(19) United States
(12) Patent Application Publication
(10) Pub. No.: US 2006/0259810 A1
(43) Pub. Date: Nov. 16, 2006

(54) Disk controller system

(76) Inventors: Mutsumi Hosoya, Fujimi (JP); Akira Fujibayashi, Sagamihara (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/181,897

(22) Filed: Jul. 15, 2005

(30) Foreign Application Priority Data
May 10, 2005 (JP) 2005-137201

(51) Int. Cl. G06F 11/00

(52) U.S. Cl. 714/4

(57) ABSTRACT

A disk controller system is provided which has a plurality of disk controller clusters connected with one another. The disk controller cluster provides an in-cluster resource availability monitor for monitoring resource availability in the cluster itself. Further, an in-system resource availability monitor is provided for monitoring resource availability of said disk controller system. The monitored informations of those in-cluster resource availability monitors are collected for composing monitored information of said in-system resource availability monitor. Based on the monitored information, an interval of issuing one or more I/O jobs over two or more disk controller clusters is arranged. This makes it possible to optimize the resource distribution of the overall system in response to a user's request not only in the disk controller but also with respect to the I/O request over two or more disk controllers.

### CROSS-REFERENCE TO RELATED APPLICATION

This invention relates to a Japanese Patent Application No. 2005-137201, the disclosures of which are incorporated herein by reference.

### BACKGROUND OF THE INVENTION

The present invention relates to a disk controller system, and more particularly to the disk controller system which is arranged to have a plurality of disk controller clusters each for controlling transfer of data between a host computer and a disk drive unit so that the system may be suitable to a large-scaled storage system where I/O jobs between the clusters take place frequently.

For reduction of TCO (Total Cost of Ownership) based on Storage Consolidation and strategic utilization of data, today, a large-scaled storage system is likely to be requested more and more. With advance of the consolidation, the storage system is required to be more scalable. Concretely, the storage system is required to keep its ports more in number, its capacity larger, its performance higher, and so forth.

On the other hand, a request for reducing the market price of storage system is increasing. The price of the storage system per unit capacity is reduced by 20% per half year. In order to follow the reducing trend, it is essential to reduce the cost of the overall system including the architecture of the storage system.

As one solution of keeping the storage system both highly scalable and less costly, there has been proposed a system called a multi-disk controller system having a plurality of disk controllers connected in cluster. The multi-disk controller enables to keep its scalability surprisingly higher by connecting a plurality of disk controllers. Further, by preparing the corresponding number of disk controllers with the user's needs, it is possible to eliminate unnecessary hardware resources, thereby being able to reduce the total cost of the multi-disk controller. Hence, the use of the multi-disk controller makes it possible to keep the storage system both highly scalable and less costly.

The foregoing disk controller of the cluster system has been described in JP-A-2004-240949.

### SUMMARY OF THE INVENTION

For reducing the TCO based on the storage consolidation as described above, it is important to introduce a storage system on a necessary and sufficient scale and make maximum use of its capability. However, a large-scaled storage system processes a great variety of requests at a time. If requests are concentrated on its partial resource, a resource contention takes place, and the essential capability of the storage system cannot be performed.

In the above case, it is effective to apply a technology of analyzing users' requests and distributing resources and allocating the tasks according to the users' requests. The user prescribes the process to be executed when a resource contention takes place to the storage system so that the storage system may execute the process to the user's request even if a resource contention takes place.

For managing the resources as described above, the prior art has been known in which a resource availability is grasped within one disk controller. In the disk controller system having a plurality of disk controllers connected as a cluster system, no prior art has been proposed for grasping and managing one or more resources for an overall disk controller system (in particular, a resource about a request over two or more disk controllers). Hence, the disk controller system having a plurality of disk controllers connected as a cluster system has been disabled to optimize the resource distribution of the overall system according to the user's request. That is, it has been difficult to both improve the scalability against the cost in the disk controller system having a plurality of disk controllers connected as a cluster system and optimize the efficiency of the overall system in light of the grasped resource availability at a time. Hence, conventionally, an attempt has been made to solve this problem by locating data ports so that an I/O request over two or more disk controllers may be suppressed as much as possible. However, keeping these restrictions is actually very difficult, so the I/O requests over two or more disk controllers frequently take place.

The present invention is made to solve the foregoing problem, and it is an object of the present invention to provide a disk controller system which enables to optimize a resource distribution of the overall system in response to the user's request about the I/O requests over two or more disk controllers.

According to an aspect of the present invention, a disk controller system having a plurality of disk controller clusters connected therewith, each disk controller cluster serving to control transfer of data between a host computer and a disk drive unit and having a monitor for monitoring resource availability in the cluster itself. Further, a monitor is provided for monitoring resource availability in the system. The monitor collects monitored information about the resource availability in the plurality of clusters so that the collected information compose the information of the monitor for the resource availability in the system. Based on the information of the monitor for monitoring the resource availability in the system, the disk controller system arranges intervals of issuing one or more I/O jobs over two or more disk controller clusters.

The disk controller cluster may be connected with a channel adapter having a connecting interface with a host computer so that the disk controller cluster may exchange the information of the monitor for monitoring the resource availability in the cluster with the host computer. Or, the disk controller clusters may be connected with one another through switch adapters each of which is connected with each adapter inside the cluster itself so that the information of the monitor for monitoring the resource availability in the cluster may be exchanged among the disk controller clusters

Further, a monitor for monitoring the resource availability in the system may be provided in an inter-cluster switch by which the disk controller cluster is connected.

Moreover, by locating an inter-cluster controller between the disk controller clusters, it is possible to provide the monitor for monitoring the resource availability in the system in the inter-cluster controller.

The resources to be monitored include a network bandwidth between the disk controller clusters, an access path bandwidth of a logical volume, a port bandwidth of a switch in the disk controller cluster, and so forth. For arranging the intervals of issuing an I/O job, a service processor unit or the like operates to refer to the condition of restricting the resource availability and the condition of releasing the resource availability and controls the mode at which the I/O job is issued, based on these conditions.

According to the present invention, a disk controller system is provided for optimizing the resource distribution of the overall system in response to the user's request with respect to the I/O request over two or more disk controllers.

### BRIEF DESCRIPTION OF THE DRAWINGS

FIG. 1 is a diagram showing a disk controller system according to an embodiment of the present invention;

FIG. 2 is a detailed block diagram showing a disk controller cluster included in the disk controller system according to the embodiment of the present invention;

FIG. 3 is a table showing monitoring states of port availabilities of a channel adapter 110 included in the disk controller system;

FIG. 4 is a table showing a condition of an availability of each resource about a data network between the disk controller clusters;

FIG. 5 is a table showing a monitoring state of a logical volume access path availability of a disk adapter 120;

FIG. 6 is a table showing a condition of an availability of each resource about each access path to the logical volume;

FIG. 7 is a table showing a monitoring state of each port availability of a switch adapter 140;

FIG. 8 is a table showing a condition of an availability of each resource about a switch port of the switch adapter 140;

FIG. 9 is a flowchart showing a process of controlling an I/O job in the disk controller system according to the embodiment of the present invention;

FIG. 10 is a block diagram showing a configuration of the disk controller clusters connected through host ports of a channel adapter, included in the disk controller system according to the embodiment of the present invention;

FIG. 11 is a block diagram showing a configuration of the disk controller clusters connected through switch ports located in the switch adapter, included in the disk controller system according to the embodiment of the present invention;

FIG. 12 is a block diagram showing a configuration of the disk controller clusters connected through inter-cluster switches included in the disk controller system according to the embodiment of the present invention;

FIG. 13 is a block diagram showing a configuration of the disk controller clusters connected through the inter-cluster switches and an inter-cluster controller, included in the disk controller system according to the embodiment of the present invention; and

FIG. 14 is a block diagram showing a configuration of the disk controller clusters through the inter-cluster controller, included in the disk controller system according to the embodiment of the present invention.

### DESCRIPTION OF THE EMBODIMENTS

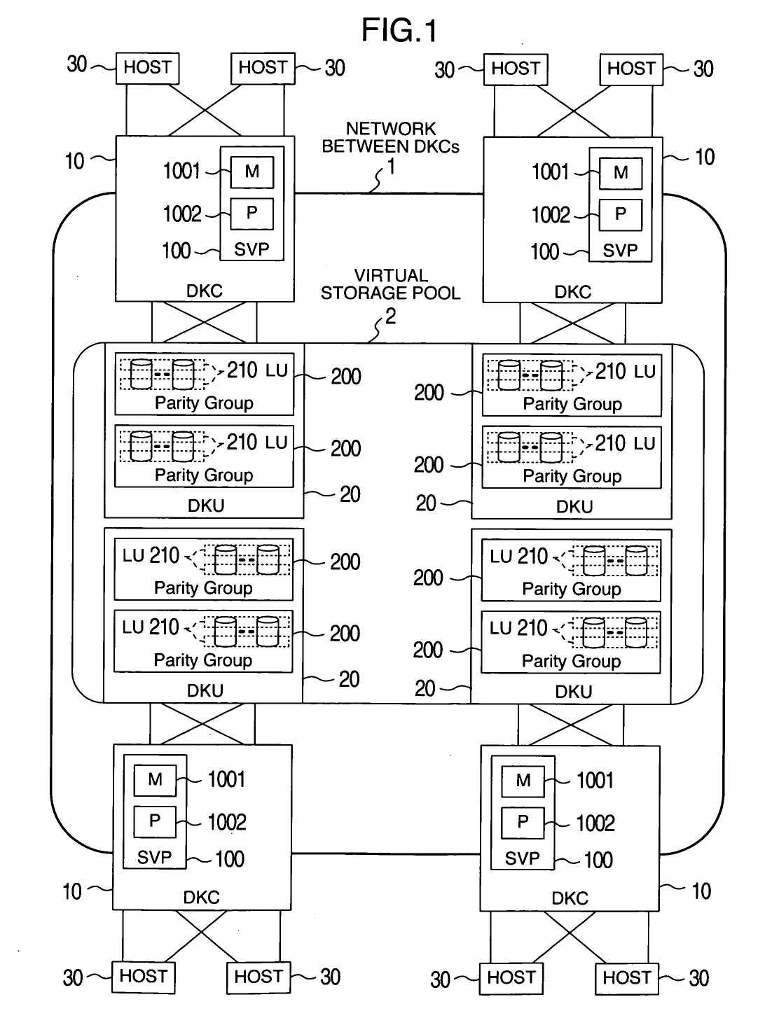

Hereafter, each embodiment of the present invention will be described with reference to FIGS. 1 to 14.

[Summary of Configuration of Disk Controller System and Monitor for Resource Availability]

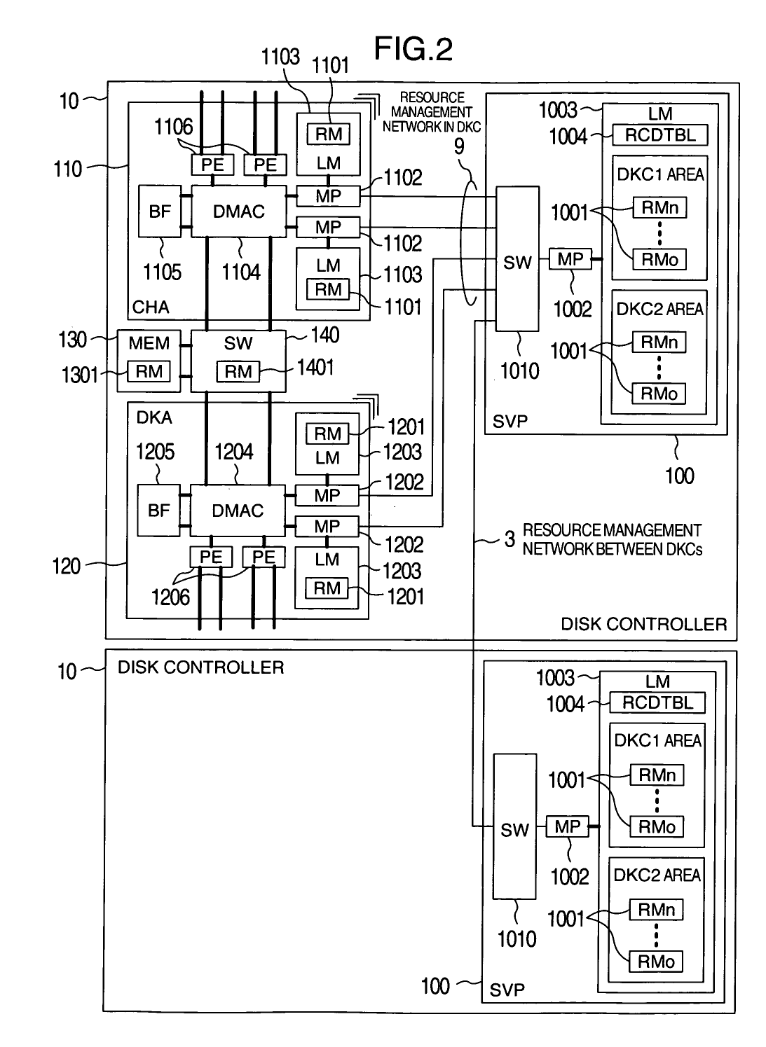

FIG. 1 is a block diagram showing a disk controller system according to an embodiment of the present invention. FIG. 2 is a detailed block diagram showing a disk controller cluster included in the disk controller system.

The disk controller cluster 10 is connected with a host computer 30 and a disk drive unit 20. In response to a data reading request given by the host computer 30, the disk controller cluster 10 gives back the data read from the disk drive unit 20 to the host computer, while in response to a data writing request given by the host computer 30, the data controller cluster 10 writes data in the disk drive unit 20 and then gives back an end status to the host computer 30. Each disk controller cluster 10 includes a service processor unit 100, which monitors and manages the resource availabilities in the cluster through the use of a resource availability monitor 1001 and a processor 1002.

Throughout the present specification, the monitor dedicated to monitoring the inside of the cluster to which the monitor belongs is called the “in-cluster resource availability monitor” and the monitor dedicated to monitoring the overall disk controller system is called the “in-system resource availability monitor”.

Each disk controller cluster 10 communicates the information of the in-cluster resource availability monitor located in the service processor with another disk controller cluster 10 through an inter-cluster network 1 of the disk controller. Through these communications, the monitored informations are collected from the plurality of in-cluster resource availability monitors, for composing the in-system resource availability monitor.

In the disk drive unit 20 is formed a parity group 200 composed by a plurality of harddisk drives in a redundant manner. The logical volume 210, based on which a storage capacity is allocated to each user, is composed in the parity group 200.

In the system having a plurality of disk controller clusters configured therein, the logical volume 210 belonging to each disk controller cluster 10 forms one virtual storage pool 2. Hence, the host computer 30 has a capability of accessing the logical volumes in all the virtual storage pool 2 under the control of the multi-disk controller without having to be conscious of the disk controller cluster that controls the target logical volume 210 to be accessed. In a case that the target logical volume belongs to the same disk controller cluster 10 as the access requesting host computer, merely by referring to the resource availability monitor located in one disk controller cluster, the resource distribution can be optimized.

On the other hand, in a case that the logical volume to be accessed belongs to the different disk controller cluster 10 from the access requesting host computer, by referring to the in-system resource availability monitor composed by the communications among the disk controller clusters 10, the resource distribution in the overall disk controller system can be optimized. More particularly, each disk controller cluster 10 arranges the issuing intervals of the I/O jobs over those disk controller clusters 10 by switching the control mode of each I/O job as referring to the in-system resource availability monitor.

The detailed configuration of the disk controller cluster 10 is illustrated in FIG. 2.

The disk controller cluster 10 is composed of a channel adapter 110, a disk adapter 120, a memory adapter 130, a switch adapter 140, and a service processor unit 100. The switch adapter 140 serves to connect the channel adapter 110, the disk adapter 120 and the memory adapter 130 with one another.

The channel adapter 110 is served as a connecting interface with the host computer 30. The disk adapter 120 is served as a connecting interface with the disk drive unit 20. The memory adapter 130 temporarily stores data to be communicated between the host computer 30 and the disk drive unit 20. The switch adapter 140 is served to connect the channel adapter 110, the disk adapter 120 and the memory adapter 130 with one another for controlling the exchange of data among them. The service processor unit 100 monitors the resources in the cluster and the resources in the overall system and saves the pieces of monitored information (simply referred to as the monitored informations) as resource information.

The channel adapter 110 includes a protocol engine 1106, a microprocessor 1102, a working memory 1103 of the microprocessor 1102, a DMA controller 1104, and a working memory 1105 of the DMA controller 1104.

The protocol engine 1106 controls a protocol of communicating with the host computer 30. The microprocessor 1102 is a processor for controlling this channel adapter 110. The DMA controller 1104 controls transfer of a DMA with another adapter.

Likewise, the disk adapter 120 includes a protocol engine 1206, a microprocessor 1202, a working memory 1203 of the microprocessor 1202, a DMA controller 1204, and a working memory 1205 of the DMA controller 1204.

The protocol engine 1206 controls a protocol of communicating with the disk drive unit 20. The microprocessor 1202 is a processor for controlling the disk adapter 120. The DMA controller 1204 controls transfer of a DMA with another adapter.

The service processor unit 100 includes a switch 1010, a microprocessor 1002, and its working memory 1003.

The switch 1010 is served to connect the channel adapter 110, the disk adapter 120 and another service processor unit with one another, for exchanging data among them. The microprocessor 1002 is a processor for executing various services.

Further, the service processor unit 100 is connected with the channel adapter 110 and the disk adapter 120 through a resource management network 9 located in the disk controller cluster. Moreover, the service processor unit 100 is also connected with a service processor unit 100 belonging to another disk controller cluster 10 through the resource management network 3 located in the disk controller cluster.

The channel adapter 110, the disk control adapter 120, the memory adapter 130, and the switch adapter 140, all of which are located in the disk controller cluster 10, operate to monitor their resource availabilities or the like and save their states in their own resource monitor areas 110.

The service processor unit 100 collects the resource information saved in the resource monitor area 1101 located in each adapter through the resource management network 9 located in the disk controller cluster and then saves the collected resource informations in the working memory 1103. The collected resource informations compose the in-cluster resource availability monitor. In collecting the resource information, the resource information saved in the resource monitor area 1101 is read as it is or the resource information is read after being worked, concretely, an average value or a maximum value over a certain term is read as the resource information.

Further, a resource condition table 1004 for controlling the I/O job is saved in the working memory 1003.

Then, the monitored informations are collected from the in-cluster resource monitors each of which is provided in each disk controller cluster. The collection of the monitored informations composes the in-system resource availability monitor.

As described above, in the disk controller system according to the present invention, each disk controller cluster 10 provides the in-cluster resource availability monitor. The monitored informations are collected from the plurality of in-cluster resource availability monitors, for composing the in-system resource availability monitor. Through the composed monitor, the resource availability of the overall system composed of the plurality of disk controller clusters can be grasped and managed. Further, by referring to the in-system resource availability monitor and the resource condition table 1004 and arranging the intervals of issuing one or more I/O jobs over two or more disk controller clusters, the resource distribution of the overall system can be optimized to the user's request. This makes it possible to optimally distribute the load, totally enhance the throughput, and optimize the number of I/Os, thereby being able to guarantee the corresponding performance with the user's request.

[Concrete Examples of Resource Availability Monitor and Resource Condition Table]

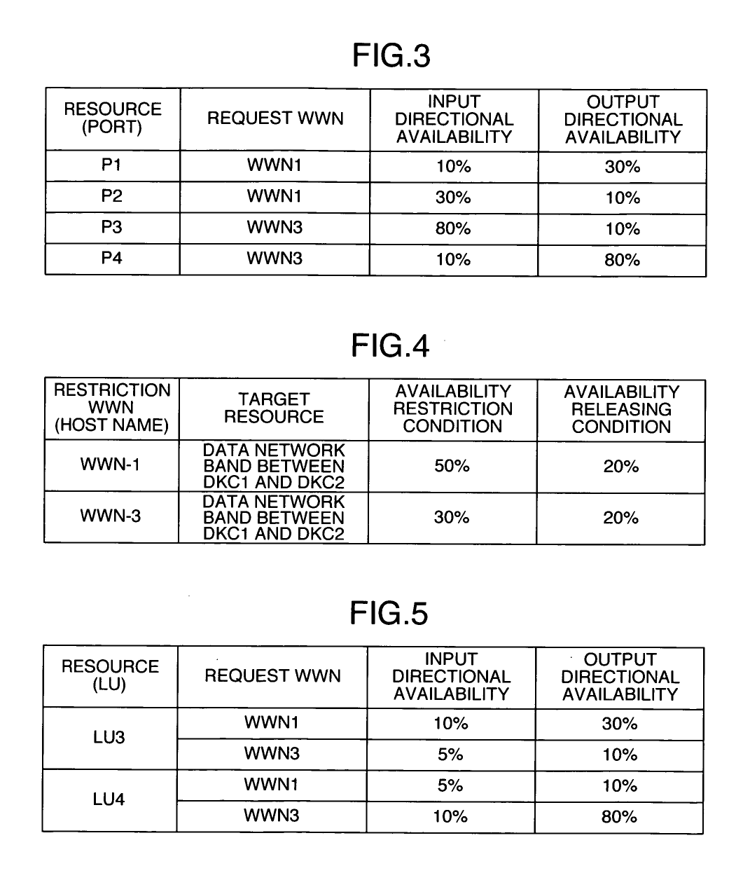

In turn, the description will be oriented to the concrete examples of the resource availability monitor and the resource condition table included in the disk controller system according to the present invention with reference to FIGS. 3 to 8.

FIG. 3 shows the monitoring state of each port availability of the channel adapter 110.

FIG. 4 is a table of a resource availability condition about the inter-cluster data network of the disk controller.

FIG. 5 shows the monitoring state of the logical volume access path availability of the disk adapter 120.

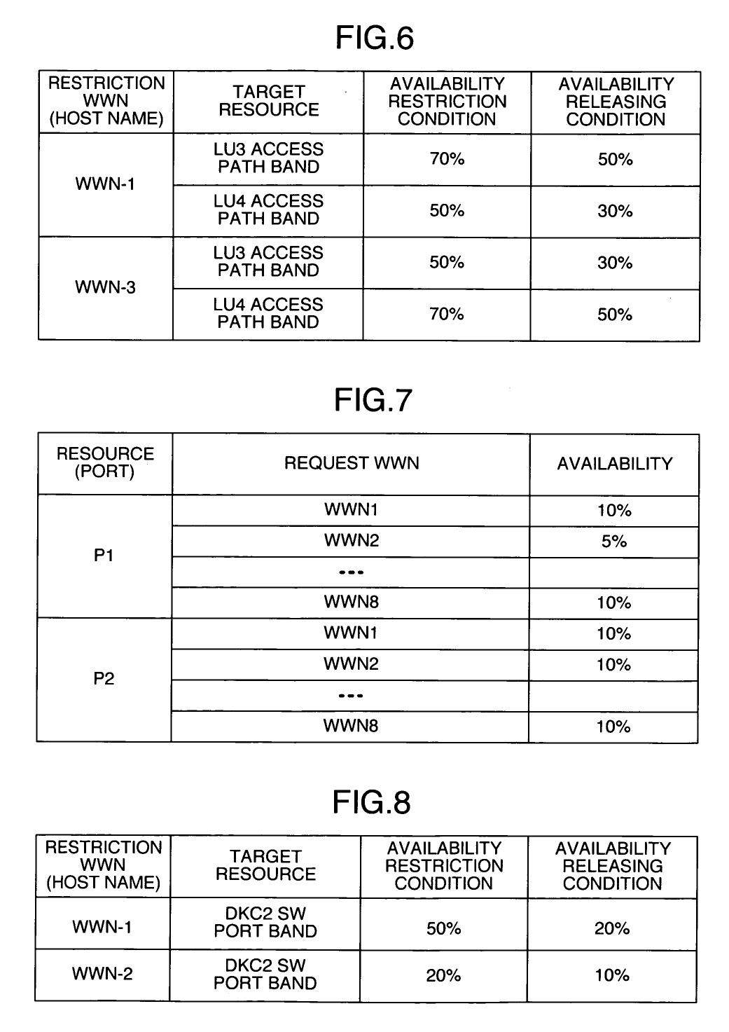

FIG. 6 is a table of a resource availability condition about an access path to the logical volume.

FIG. 7 shows the monitoring state of each port availability of the switch adapter 140.

FIG. 8 is a table of a resource availability condition about each switch port of the switch adapter 140.

As shown in FIG. 3, the channel adapter 110 manages an input direction availability and an output direction availability as its resources. Herein, the host computer name (for example, the World Wide Name of the Fibre Channel protocol) to a P1 port indicates the access availability of WRITE from the host WWN-1 is 10% and the READ access availability from the host WWN-1 is 30%.

The restriction condition and the releasing condition of the I/O job thereabout are as shown in Table of FIG. 4. Herein, for the host WWN-1, if the availability of the data network between DKC1 and DKC2 is 50% or more, an I/O request for the I/O job to be executed through the use of the data network between DKC1 and DKC2 is restricted, while if the availability is 20% or less, the restriction of issuing the I/O job to be executed through the use of the data network between DKC1 and DKC2 is released.

By managing and restricting the availability of the port in this channel adapter 110, the I/O job accompanied with transfer of data between the disk controller clusters is properly scheduled. This makes it possible to enhance a total throughput.

As shown in FIG. 5, the disk adapter 120 manages an availability of an access path to a logical volume as its resource. Herein, the availability of a writing access to be given to the LU 3 logical volume to the host WWN-1 is 10%, while the availability of a reading access is 30%.

The restriction condition and the releasing condition of the I/O job thereabout are as shown in Table of FIG. 4. Herein, about an I/O request given by the host computer WWN-1, an availability of 70% of an access path to the LU3 logical volume is a critical level and an availability of 30% of an access path to the LU4 logical volume is a critical level. When the availabilities of the access path to the LU3 logical volume and the LU4 logical volume are made lower to 50% and 30%, the restriction of the access paths are released.

By managing the logical volume access path in the disk adapter 120 and restricting the use of the access path as described above, it is possible to optimally arbitrate an access contention to a logical volume.

As shown in FIG. 7, the switch adapter 140 manages an availability of a switch port as its resource. Herein, the availability of the switch port P1 from the host WWN-1 is indicated as 10%.

Further, the restriction condition and the releasing condition of the I/O job thereabout are as shown in Table of FIG. 8. Herein, the 50% availability of a switch port bandwidth to the host computer WWN-1 of DKC2 is a critical level. When the availability is made lower to 20%, the restriction of the switch port is released.

By managing the port bandwidth in the switch adapter 140 and restricting the use of the port as described above, it is possible to carry out the optimal arbitration when using the switch adapter 140.

[Control of I/O Job]

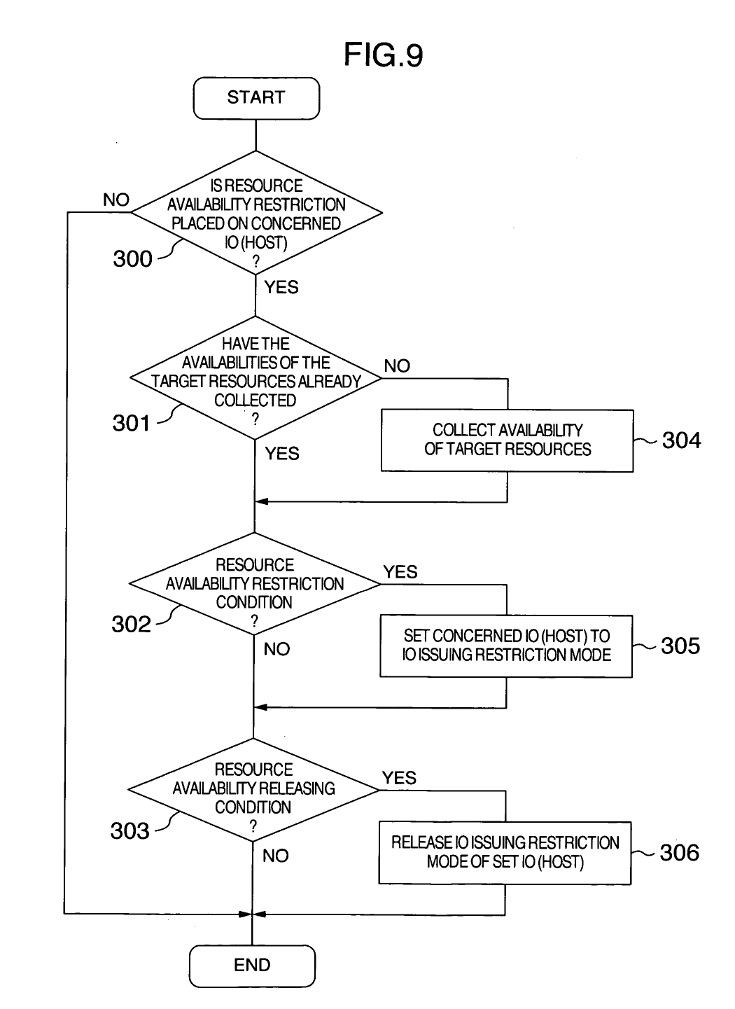

In turn, the description will be oriented to the control of the I/O job with reference to FIG. 9.

FIG. 9 is a flowchart illustrating the control of the I/O job in the disk controller system according to the present invention.

The service processor unit collects the information of the resource availability about each resource as indicated in the concrete example of the foregoing resource availability monitor. By referring to the restriction condition and the releasing condition about the concerned resource indicated in the resource availability condition table, the service processor unit operates to optimize the resource distribution.

Concretely, the algorithm shown in the flowchart of FIG. 9 is executed to arrange the intervals of issuing I/Os by switching the control mode about the I/O job. At first, it is determined if the concerned I/O request concerns with the restriction based on the resource availability (step 300). If yes, it is checked if the availability of the target resources required for determining if the I/O request is restricted on the resource availability have been already collected (step 301). If not yet, the process is executed to collect the information required from the monitors of the target resources through the resource management network (to be discussed below). Afterwards, the restriction condition of the resource availability is compared with the current resource availability (step 302). If the resource about the concerned I/O job exceeds the restriction condition, the execution of the concerned I/O job is set to be controlled under the restriction mode of issuing an I/O (step 305), and the intervals of issuing the concerned I/O job are arranged.

Further, the resource releasing condition is compared with the current resource availability (step 303). If the current resource availability is lower than the resource releasing condition about the concerned I/O job, the concerned I/O job is released from the I/O issuing restriction mode (step 306) and is put under the normal operation mode.

As described above, when executing the I/O job over two or more disk controller clusters, if the value indicated in the in-system resource availability monitor that reflects the current resource availability does not meet the resource availability restriction condition that prescribes the resource availability required for the concerned job, the issuing number of the concerned jobs is restricted. The restriction is continued until the value indicated in the in-system resource availability monitor meets the resource availability releasing condition that prescribes the resource availability required for releasing the restriction. This makes it possible to stably execute the I/O jobs as matching to the temporary variation of the resource availability.

[Variation of System Embodiments of Disk Controller System]

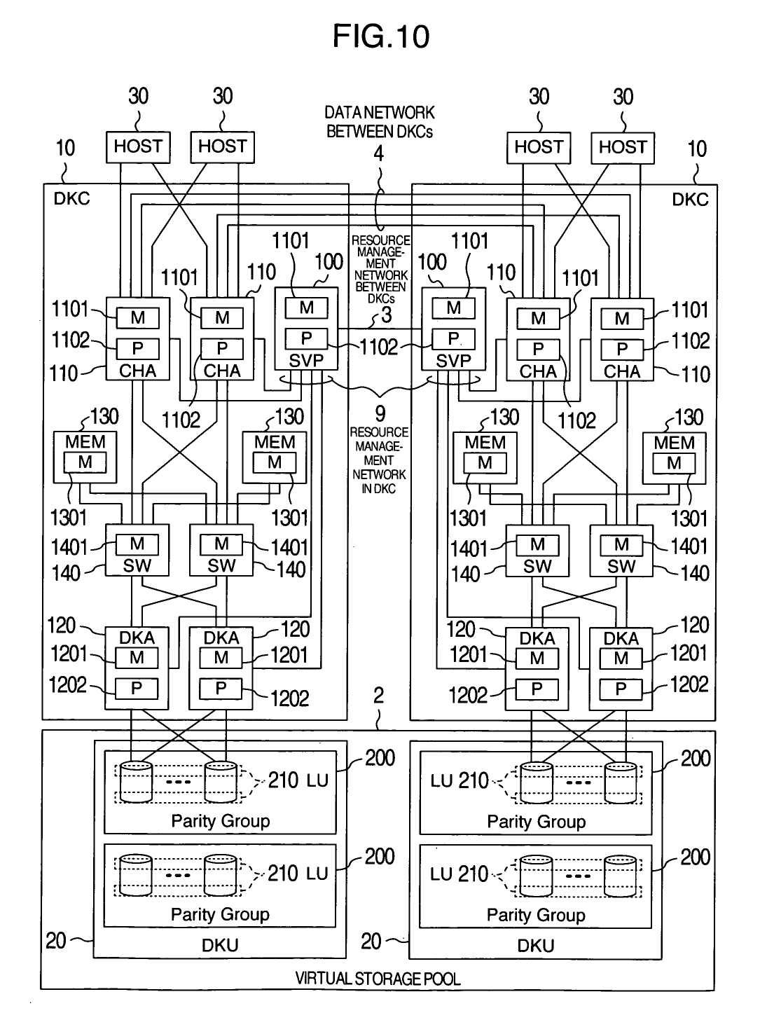

Hereafter, the description will be oriented to various system embodiments of the disk controller system according to the present invention with reference to FIGS. 10 to 14.

(I) The Embodiment in Which the Disk Controller Clusters are Connected Through the Host Ports of the Channel Adapters

FIG. 10 shows the configuration of the disk controller system according to the present invention, in which configuration the disk controller clusters are connected through the host ports of the channel adapters.

In this system embodiment, the disk controller clusters 10 are connected through the host ports of the channel adapters. The data is transferred through the inter-cluster data network 4. The resources are transferred through an inter-cluster resource management network 3 connecting with the service processor unit 100 of each disk controller cluster 10.

The disk controller cluster 10 is arranged to have the channel adapter 110, the disk adapter 120, the memory adapter 130, the switch adapter 140, and the service processor unit 100. The switch adapter 140 is served to connect the channel adapter 110, the disk adapter 120 and the memory adapter 130 with one another.

Those components have the same functions as those shown in FIG. 2.

Those disk controller clusters 10 are connected with one another at the channel adapters 110 of those disk controller clusters 10 through the inter-cluster data network 4. The service processor units 100 of those clusters 10 are connected through the inter-cluster resource management network 3.

The service processor unit 100 collects the monitored informations of the in-cluster resource availability monitors through the in-cluster resource management network 9. Also, one service processor unit 100 exchanges the information of the in-cluster resource availability monitor with another service processor unit 100. This information exchange composes the in-system resource availability monitor.

In a disk controller system having a plurality of disk controller clusters 10 connected with one another, the host computer 30 enables to access all the virtual storage pools 2 under the control of the disk controller system without having to be conscious of which of the disk controller clusters controls a target logical volume (to be accessed). In a case that the target logical volume belongs to the same disk controller cluster as the cluster with which the access-requesting host computer 30 is concerned, by referring to the resource availability monitor in that disk controller cluster, it is possible to optimize the resource distribution.

On the other hand, in a case that the target logical volume belongs to the different disk controller cluster from the cluster with which the access-requesting host computer 30 is concerned, the resources of those disk controller clusters are used through the inter-cluster data network 4. In this case, by referring to the monitored information of the in-system resource availability monitor composed of the communications being executed through the inter-cluster resource management network 3, it is possible to optimize the resource distribution of the overall disk controller system.

For example, when the availability of the port of the channel adapter shown in FIG. 3 becomes so large that the network bandwidth of the inter-cluster data network 4 may exceed the restriction condition of the availability shown in FIG. 4, the process is shifted to the I/O issuance restriction mode, at which suppressed is the issuance of such an I/O job as bringing about a data flow on the inter-cluster data network 4 between the DKC1 and the DKC2.

In the disk controller system according to this embodiment, those disk controller clusters are connected with one another through their channel adapters. This connection eliminates the necessity of a special connecting hardware mechanism for composing the disk controller system. That is, by connecting those disk controller clusters with one another through their channel adapters, it is possible to suit the system functions to the user's request and thereby reduce the hardware cost as optimizing the resource distribution of the overall system.

(II) Configuration of Disk Controller Clusters Connected Through Switch Port Located Inside Switch Adapter

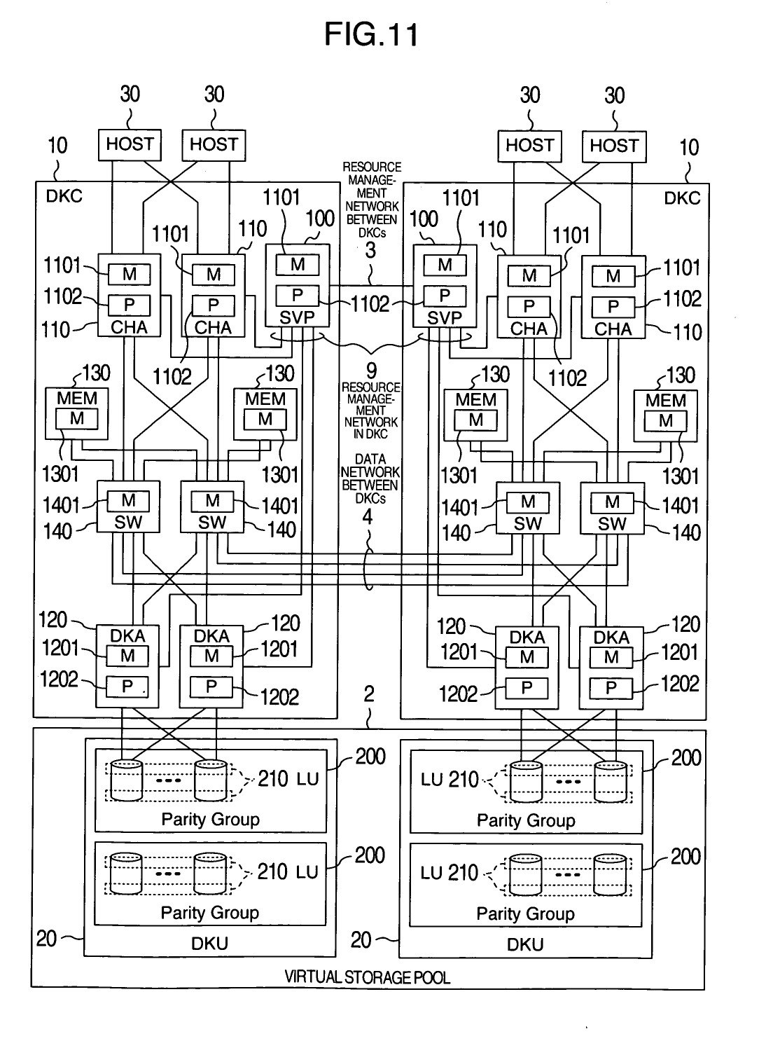

FIG. 11 shows a configuration of the disk controller system according to the present invention. The disk controller system is configured to have disk controller clusters connected with one another through the switch ports located inside the switch adapters

In this system configuration, one disk controller cluster 10 is connected with another cluster through the switch port located inside the switch adapter. The data are transferred between the clusters 10 through the inter-cluster data network 4 and the resource are transferred through the inter-cluster resource management network 3 to which the service processor unit 100 of each cluster 10 is connected.

The configuration of each cluster 10 and the function of each component are the same as those as described with respect to the item (I).

The disk controller clusters 10 are connected with one another at the switch adapters through the inter-cluster data network 4 and at the service processor unit 100 through the inter-cluster resource management network 3.

The service processor unit 100 collects the monitored information of the in-cluster resource availability monitor through the in-cluster resource management network 9. Further, the exchange of the monitored informations of the in-cluster resource availability monitors between the service processor units 100 composes the in-system resource availability monitor.

Also in this system configuration, like the item (I), in a case that the target logical volume belongs to the same disk controller cluster as the cluster with which the access requesting host computer is concerned, by referring to the resource availability monitor located within one disk controller cluster, it is possible to optimize the resource distribution.

On the other hand, like the item (I), in a case that the target logical volume belongs to the different disk controller cluster from the cluster with which the access requesting host computer is concerned, the resources of those clusters are used through the inter-cluster data network 4. Also in this case, by referring to the monitored information of the in-system resource availability monitor composed of the communications among the clusters through the inter-cluster resource management network 3, it is possible to optimize the resource distribution of the overall disk controller system.

For example, when the availability of the port of the switch adapter shown in FIG. 7 becomes so large that the switch port bandwidth of the DKC2 exceeds the availability restriction condition shown in FIG. 8, the process is shifted to the I/O issuance restriction mode, at which suppressed is the issuance of such an I/O job as using the switch port of the related DKC 2.

In the disk controller system according to this embodiment, those disk controller clusters are connected at their switch adapters. This connection does not consume the network bandwidth of the host port of the channel for composing the disk controller system. By connecting those disk controller clusters with one another at their switch adapters, it is possible to suit the system function to the user's request and save the valuable network bandwidth of the host port as optimizing the resource distribution of the overall system.

Also in this system configuration, not only the in-cluster resource availability monitors but the in-system resource availability monitor are distributively located in the service processor unit 100 inside each cluster 10.

According to the foregoing system configuration, by composing the in-system resource availability monitor in each of those disk controller clusters 10, the optimization of the resource distribution on the overall system is made possible merely by referring to the monitored information in one cluster. As described earlier, the distributive location of the in-system resource availability monitors in those disk controller clusters 10 makes it possible to more efficiently optimize the resource distribution on the overall system.

(III) Configuration of Disk Controller Clusters Connected Through Inter-cluster Switches

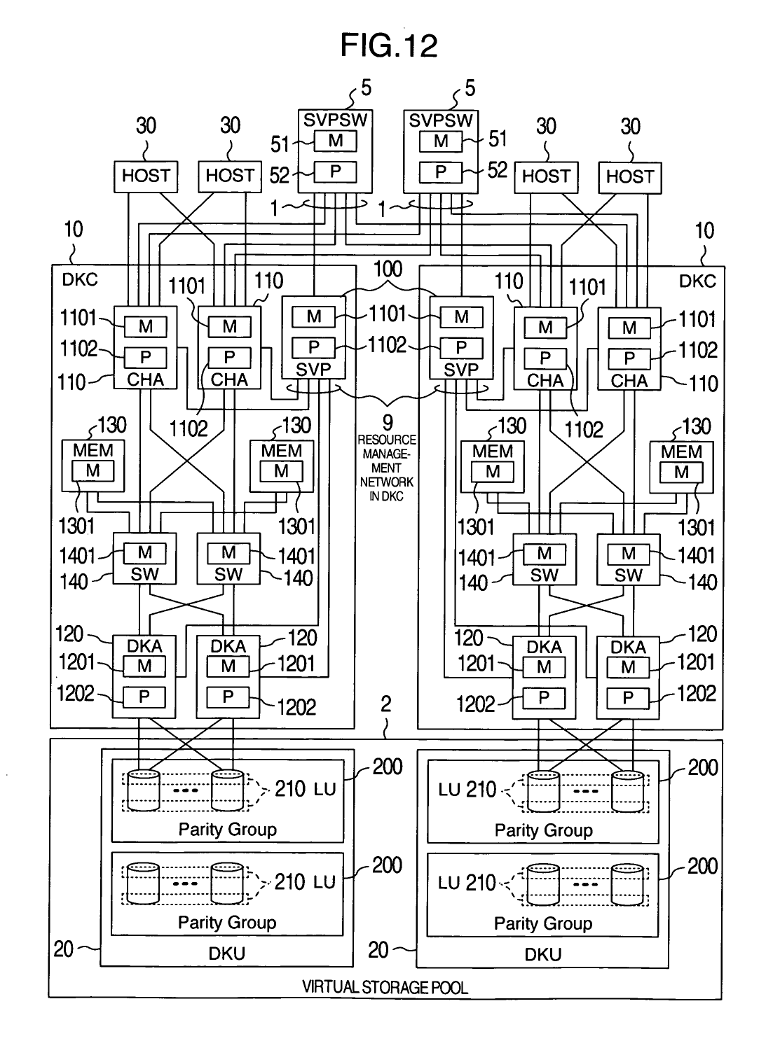

FIG. 12 shows a configuration of the disk controller system according to the present invention. The disk controller clusters are connected through the inter-cluster switches.

In the system configurations of (I) and (II), the in-system resource availability monitor is located in the service processor unit 100 located in each of the clusters 10.

In this system configuration, the inter-cluster switch is provided between the disk controller clusters 10 and the in-system resource availability monitor is composed in the inter-cluster switch for concentratively managing the resources on the overall system.

The configuration of each disk controller cluster 10 and the function of each component are the same as those described about the foregoing items (I) and (II).

Those disk controller clusters 10 are connected with one another at their channel adapters 110 and service processor units 100 through the inter-cluster network 1.

The service processor unit 100 collects the monitored information of the in-cluster resource availability monitor through the in-cluster resource management network 9. Further, the collection of the monitored information of the in-cluster resource availability monitor from each service processor unit 100 through the effect of the inter-cluster switch 5 composes the in-system resource availability monitor inside the inter-cluster switch 5.

Like the foregoing system configuration, in a case that the target logical volume (to be accessed) belongs to the same disk controller cluster 10 as the cluster with which the access requesting host computer is concerned, by referring to the resource availability monitor located in that cluster 10, it is possible to optimize the resource distribution.

On the other hand, in a case that the target logical volume belongs to the different disk controller cluster from the access requesting host computer, the inter-cluster switch 5 uses the resources of two or more clusters 10. In this case, the inter-cluster switch 5 enables to optimize the resource distribution on the overall disk controller system by referring to the in-system resource availability monitor composed in itself.

For example, when the availability of the port of the cluster switch 5 becomes so large that the switch port bandwidth between the clusters may exceed the availability restriction condition, the process is shifted to the I/O issuance restriction mode, at which is suppressed the issuance of such an I/O job as using the switch port of the concerned cluster switch 5.

According to the foregoing system configuration, by composing the in-system resource availability monitor in the inter-cluster switch 5, it is possible to more efficiently update the in-system resource availability monitor. The concentrative location of the in-system resource availability monitor into the inter-cluster switch makes it possible to more easily optimize the resource distribution on the overall system. In particular, if lots of clusters are provided, this optimizing effect is made larger.

(IV) Configuration in Which the Disk Controller Clusters are Connected with the Inter-Cluster Switches and the Hosts are also Connected with the Inter-Cluster Switches

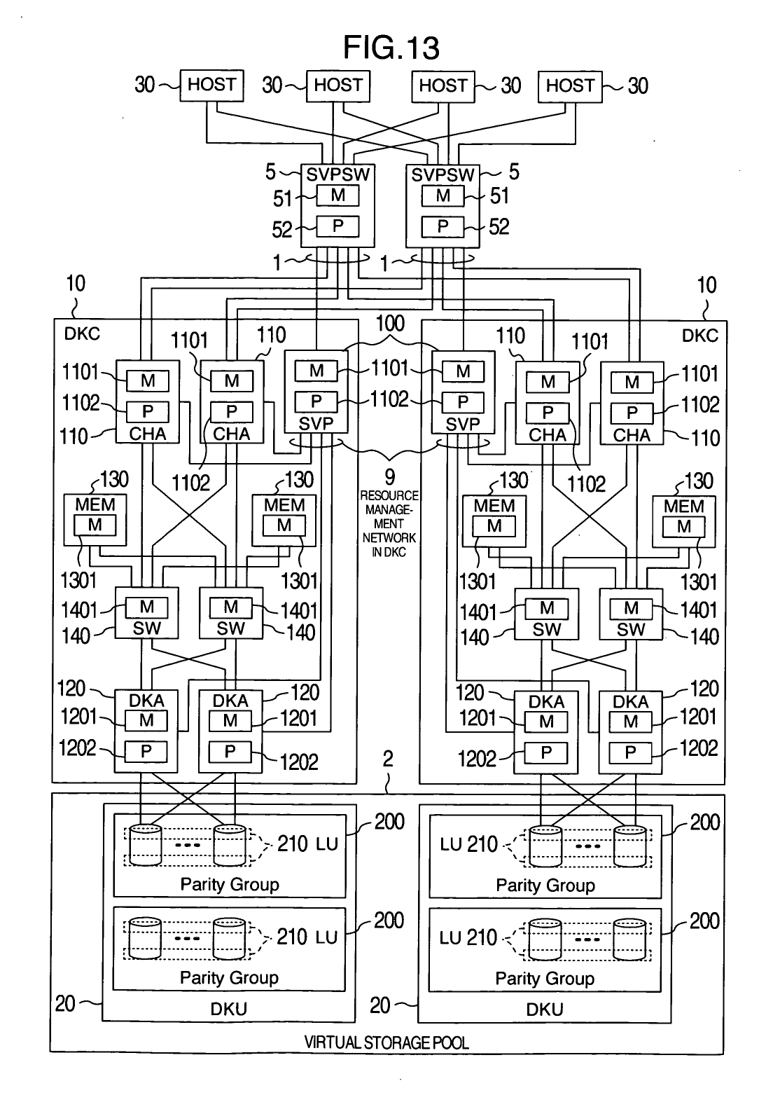

FIG. 13 shows a configuration of the disk controller system according to the present invention. In this configuration, the disk controller clusters are connected with one another through the inter-cluster switches and the hosts are also connected through the inter-cluster switches.

This system configuration is analogous to the configuration of the item (III) except that the host computer is not directly connected with the channel adapter but connected with the inter-cluster switch.

As shown in FIG. 13, the inter-cluster switch 5 is connected between the host computer 30 and the disk controller adapter 10. Then, the channel adapter 110 of the disk controller cluster 10 includes a connecting interface with the inter-cluster switch 5.

Like the configuration of the item (III), those disk controller clusters 10 are connected between the channel adapters 110 and the service processor units 100 through the inter-cluster network 1. The collection of the monitored informations of the in-cluster resource availability monitors composes the in-system resource availability monitor located inside the inter-cluster switch 5.

According to this system configuration, the host computers 30 are connected through the inter-cluster switches 5. This connection makes it possible to enhance the connectivity between the disk controller clusters and the host computers and the manageability of the host computers. In particular, in a case that the in-system resource availability monitors are concentratively located in the inter-cluster switch 5, this concentrative location has an excellent affinity with this connection.

(V) Connection of the Disk Controller Clusters Through Inter-Cluster Controllers

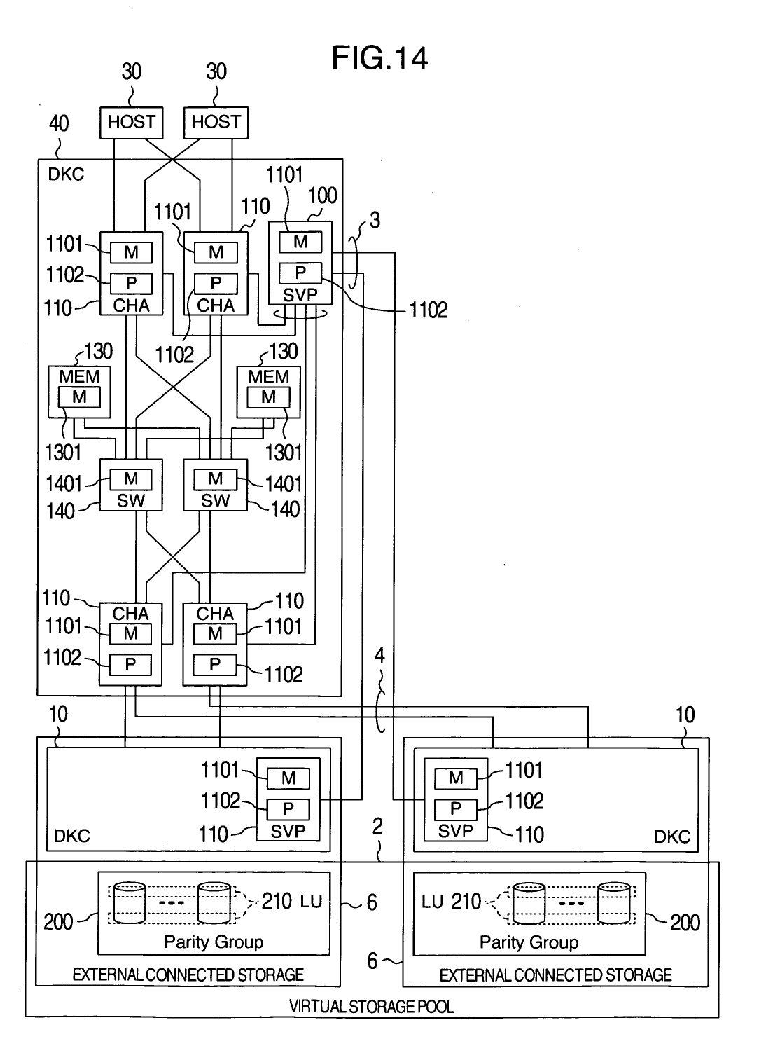

FIG. 14 shows a configuration of the disk controller system according to the present invention. In this configuration, the disk controller clusters are connected through the inter-cluster controllers.

In this system configuration, the inter-cluster controllers are provided for connecting those disk controller clusters with the host computers. The in-system resource availability monitor is composed in the inter-cluster controller so that the resources over the overall system may be concentratively managed.

The inter-cluster controller 40 connects the host computer 30 with the disk controller cluster 10. The inter-cluster controller 40 includes a channel adapter 110, a memory adapter 130, a switch adapter 140, and a service processor unit 100.

The channel adapter 110 is served as a connecting interface with the host computer 30 and the disk controller cluster 10. The memory adapter 130 temporarily stores the data transferred between the host computer and the disk controller cluster. The switch adapter 140 connects the channel adapter with the memory adapter, for composing the internal network through which the exchange of data is controlled. The service processor unit 100 has a function of monitoring the resources in the cluster and those of the overall system and saving the monitored results as the resource information.

Though removed in FIG. 14, the configuration of the disk controller cluster 10 and the function of each component are the same as those described about the items (I) to (IV).

The service processor unit 100 located in the disk controller cluster 10 collects the monitored informations of the in-cluster resource availability monitors through the resource management network in the disk controller cluster. Further, the inter-cluster controller 40 collects the monitored informations of the in-cluster resource availability monitors from the service processor unit 100 located in each disk controller cluster 10. The collection of the monitored informations composes the in-system resource availability monitor in the service processor unit 100 inside the inter-cluster controller 40.

According to this system configuration, the plural disk controller clusters 10 are connected through the inter-cluster controller 40. This connection makes it possible to more easily control the optimization between the clusters. In particular, by making use of the function of a cache memory included in the inter-cluster controller, it is possible to enhance the performance of the overall disk controller system.

It should be further understood by those skilled in the art that although the foregoing description has been made on embodiments of the invention, the invention is not limited thereto and various changes and modifications may be made without departing from the spirit of the invention and the scope of the appended claims.

1. A disk controller system having a plurality of disk controller clusters connected therewith, each of said disk controller clusters being served to control transfer of data between a host computer and a disk drive unit, comprising:
an in-cluster resource availability monitor provided in each of said disk controller clusters, said monitor for monitoring resource availability of said disk controller cluster in which said monitor is provided; and
an in-system resource availability monitor for monitoring resource availability of said disk controller system;
wherein monitored informations of said plurality of in-cluster resource availability monitors are collected, for composing monitored information of said in-system resource availability monitor, and
an interval of issuing one or more I/O jobs over two or more disk controller clusters is arranged on the basis of said monitored information of said in-system resource availability monitor.

2. A disk controller system as claimed in claim 1, wherein said disk controller cluster provides a channel adapter having a connecting interface with said host computer and said plurality of disk controller clusters are connected with one another through their channel adapters so that the monitored information of said in-cluster resource availability monitor may be exchanged among said plurality of disk controller clusters.

3. A disk controller system as claimed in claim 1, wherein said disk controller cluster includes:
a channel adapter having a connecting interface with said host computer;
a disk adapter having a connecting interface with said disk drive unit;
a memory adapter for temporarily storing data to be transferred between said host computer and said disk drive unit; and
a switch adapter for connecting said channel adapter, said disk adapter and said memory adapter with one another, for composing an internal network, and
said plurality of disk controller clusters are connected with one another through said switch adapters so that information of said in-cluster resource availability monitor may be exchanged among said plurality of disk controller clusters.

4. A disk controller system as claimed in claim 1, wherein each of said disk controller clusters provides said in-system resource availability monitor.

5. A disk controller system as claimed in claim 1, wherein said disk controller clusters are connected through inter-cluster switches and said in-system resource availability monitor is provided in said inter-cluster switch.

6. A disk controller system as claimed in claim 5, wherein said host computer is connected with said inter-cluster switch.

7. A disk controller system having a plurality of disk controller clusters connected through an inter-cluster controller, each of said disk controller clusters serving to control transfer of data between a host computer and a disk drive unit, comprising:
an in-cluster resource availability monitor provided in each of said disk controller clusters, said monitor for monitoring resource availability in said disk controller cluster in which said monitor is provided; and
an in-system resource availability monitor for monitoring resource availability of said disk controller system,
wherein monitored informations of said plurality of in-cluster resource availability monitors. are collected, for composing monitored information of said in-system resource availability monitor and an interval of issuing one or more I/O jobs over two or more disk controller clusters is arranged on the basis of said monitored information of said in-system resource availability monitor.

8. A disk controller system as claimed in claim 1, wherein when executing an I/O job over two or more disk controller clusters, if a value given by said in-system resource availability monitor does not meet a resource availability restriction condition that prescribes a resource availability required for said type of I/O job, the issuing number of those I/O jobs is restricted.

9. A disk controller system as claimed in claim 8, wherein until a value given by said in-system resource availability monitor reaches a resource available releasing condition that prescribes a resource availability required for releasing said restriction, the issuing number of those I/O jobs is restricted.

10. A disk controller system as claimed in claim 1, wherein a resource to be monitored is any one of a network bandwidth between said disk controller clusters, an access path bandwidth of a logical volume, and a port bandwidth of a switch in said disk controller cluster.

11. A disk controller system having a plurality of disk controller clusters connected with one another, each of said disk controller clusters serving to control transfer of data between a host computer and a disk drive unit, comprising:
an in-cluster resource availability monitor provided in each of said disk controller clusters, said monitor for monitoring resource availability in said disk controller cluster in which said monitor is provided; and
an in-system resource availability monitor for monitoring resource availability of said disk controller system;
wherein monitored informations of said in-cluster resource availability monitors are collected, for composing monitored information of said in-system resource availability monitor.

12. A disk controller system having a plurality of disk controller clusters connected with one another, each of said disk controller clusters serving to control transfer of data between a host computer and a disk drive unit, said disk controller cluster comprising:
a service processor unit;
a channel adapter having a connecting interface with said host computer;
a disk adapter having a connecting interface with said disk drive unit;
a memory adapter for temporarily storing data to be transferred between said host computer and said disk drive unit; and
a switch adapter for connecting said channel adapter, said disk adapter and said memory adapter with one another for composing an internal network, and
wherein said service processor unit of said disk controller cluster provides an in-cluster resource availability monitor for monitoring resource availability in said disk controller cluster and a table for holding a resource availability restriction condition and a resource availability releasing condition,
said service processor unit of said disk controller cluster provides an in-system resource availability monitor for monitoring resource availability of said disk controller system,
monitored informations of said in-cluster resource availability monitors are collected for composing monitored information of said in-system resource availability monitor, and
a mode of issuing one or more I/O jobs over two or more of said disk controller clusters is switched on the basis of the monitored information of said in-system resource availability monitor and values contained in said table for holding said resource availability restriction condition and said resource availability releasing condition.
